(19) United States
(12) Patent Application Publication
(10) Pub. No.: US 2013/0211638 A1
(43) Pub. Date: Aug. 15, 2013

(54) Method of regulation of tarque in hybrid transmission

(71) Applicants: Sergei MAKAVEEV, Toronto (CA); Mikalai Putseyeu, Vitebsk (BY); Uladzimir Putseyeu, Vitebsk (BY); Pavel Makaveev, Toronto (CA)

(72) Inventors: Sergei MAKAVEEV, Toronto (CA); Mikalai Putseyeu, Vitebsk (BY); Uladzimir Putseyeu, Vitebsk (BY); Pavel Makaveev, Toronto (CA)

(73) Assignee: Mr. Sergei makaveev, Toronto (CA)

(21) Appl. No.: 13/450,398

(22) Filed: Aug. 31, 2012

(51) Int. Cl. B60W 20/00

(52) U.S. Cl. CPC B60W 20/108
USPC 701/22; 180/65.22; 903/902

(57) ABSTRACT

Invention provides increase uniformity of rotation frequency in a hybrid transmission in co-operation of internal combustion engine and electric motor.

Method includes processing of requests for torque or braking, signal processing of the current state of engine, battery and transmission, issuing commands by engines and transmissions (At the same time an additional process information about the pulsations of torque in internal combustion engine per revolution of the shaft due to the number of its cylinders), maintenance, occupancy, speed and other parameters.

Thus system is executed with possibility of receiving an information as from sensor, calculation, from the help tables brought in memory of system or a combination of named ways, and the electric motor generates size of the twisting or brake moment on time and an angle of rotation of a shaft depending on size of a twisting moment of an internal combustion engine on a shaft angle of rotation.

### AREA WHICH THE INVENTION CONCERN

Aspects of the invention relate to systems management hybrid transmission vehicles and other vehicles. The system improved so that increase the uniformity of rotation of the internal combustion engine paired with an electric motor, thereby increasing comfort with use of the vehicle, durability, and reduced environmental emissions.

### Prior Level of Technics

System of Torque control is usually used during joint work between combustion engines and electric motor's to match requested torque. In situation when electric motor has insufficient moment, or has limited amount of energy in the batteries, it starts combustion engine. Next, the control system can change the input of each engine in overall torque. But if the torque is developed by an electric motor for one revolution of the shaft is stable enough, the moment of combustion engine can be changed to negative values for one revolution of the shaft.

Patent Engine control system for torque management in a hybrid power train system (application Ser. No. 12/251,424 Publication number: US 2009/0118932 A1, Filing date: Oct. 14, 2008, Issued patent: U.S. Pat. No. 8,000,866 (Issue date Aug. 16, 2011) implies that: A method for controlling the engine includes monitoring an operator torque request, commanding operation of the hybrid transmission in a continuously variable operating range state, determining engine commands comprising a first engine torque request and a second engine torque request based upon the operator torque request and the operation of the hybrid transmission, determining an engine torque constraint comprising a maximum engine torque based upon a capacity of the hybrid transmission to react the engine torque, and controlling engine operation based upon the first engine torque request only when the second engine torque request exceeds the engine torque constraint.

Patent Torque management algorithm for hybrid electric vehicles (U.S. Pat. No. 7,295,902, Filing date: Apr. 30, 2004, Issue date: Nov. 13, 2007, application Ser. No. 10/836,799) selecting an engine torque value.

Application for a patent: Torque management method for hybrid electric motor (application Ser. No. 12/680,778, Publication number: US 2010/0286855 A1, Filing date: Sep. 27, 2008) indicates that: The method includes torque synthesis and limitation in electric driving mode, torque synthesis and limitation in electricity generating mode, and torque arbitrating management. Wherein, the torque arbitrating management arbitrates torque according to its priority, and sends the torque request with the highest priority to a motor controller.

These applications and patents reveal composition of the systems and their functioning, but can be reduced to find method of summing the average torque of combustion engine in cooperation with a battery and electric motor.

However, these systems and methods for their operation do not consider torque fluctuation of the angle of its shaft in combustion engine.

If you examine a four-stroke combustion engines in which the positive value of the moment of rotation generates by the angle of rotation of the shaft it would take very little time in one, two, three and four cylinder, which are most often used in hybrid units, such as cars.

In particular, uneven rotation leads to the vibrations of such hybrids at idling speed and at low loads. Vibration is always a negative impact on comfort, transmission control system, fuel consumption and battery charge.

Accordingly, there is a need for a method to reduce uneven torque on the angle of rotation of the shaft.

### SUMMARY OF THE INVENTION

Work of an internal combustion engine torque change the angle of rotation of the shaft is cyclically repeated.

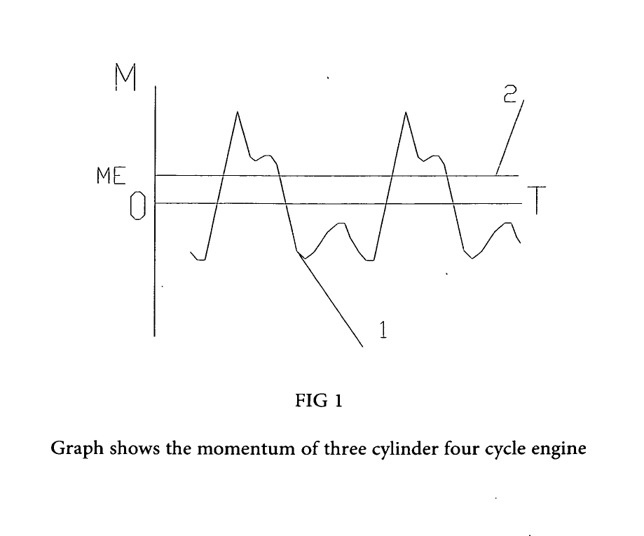

In FIG. 1 shows the flow of the moment M (curve 1) on angle of rotation T of a shaft at a three-cylinder four-cycle internal combustion engine. As can be seen from the graph, time takes negative values. Direct Line 2 shows conditional average mean ME value of the moment that does not exist in reality, but this value is used by known control system, adding it at the time of the electric motor.

### FIG. 1

Modern internal combustion engines are equipped with sensors that allow defining the coordinate of the rotation angle of the motor shaft, amount of intake air, fuel and other parameters, which allow determining the moment, depending on the angle of rotation of the shaft from calculation as well as from tables.

In the proposed control system the moment applied by the electric motor to the moment of the combustion engine is also uneven throughout the angle of rotation the shaft so that the total angular momentum for the revolution of the hybrid setup had the desired uniformity, for example, had no sites with negative total moment. This will avoid the acceleration and deceleration of the rotating masses of a hybrid setup, which reduces energy loss and leads to fuel savings, reduces vibration and increase comfort as well as durability of the transmission.

The greatest effect will be at partial load on the internal combustion engine and low speed, such as at idle.

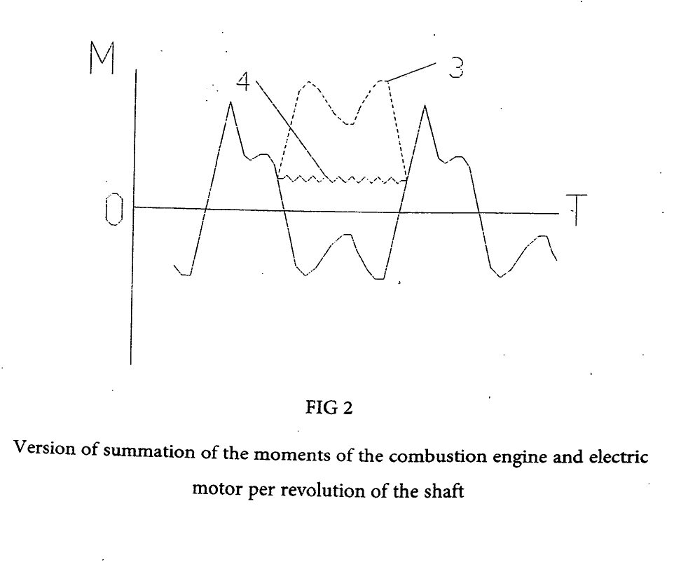

FIG. 2 shows an embodiment of the torque control method of a hybrid

### FIG. 2

This flow chart is repeated four-time three-cylinder of internal combustion engine of FIG. 1.

On one of the areas of a graph where moment begins to significantly decline, adjustable moment 3 (dashed line) is applied from the electric motor. The result of addition would be a part of a moment 4 (zigzag line).

Value of the moment in transmission is aligned with the angle of rotation of the shaft, thus saving fuel, reducing emissions into the environment, improving comfort.

Depending on operating conditions and ICE design can additionally use the following.

Torque of the electromotor pulses on a shaft turning angle. This will maximum to saves power of a batteries.

Torque of the electromotor works continuously, but changing on a shaft turning angle. It will increase acceleration of an ICE, such as if there is a necessity to increase speed.

To create a high uniformity of rotation, motor's torque have to pulse to the angle of rotation of the shaft, and with increase at decreasing torque of internal combustion engine, and with decrease at increasing torque in the engine. The momentum of the electric motor can be added to the specific area of ICE torque graph and in amount, which will result in desirable uniformity of rotation.

If torque of an electric motor delivers continuously, but changing from the smallest positive value, and increases with decrease in torque of an internal combustion engine, and decreases with increase in a torque of an internal combustion engine, reduce time for transition from the minimum frequency of rotation to the maximum.

Since unevenness of rotation in ICE depends on the rotational speed, it is necessary that torque of an electric motor should be delivered depending on the degree of unevenness of rotation, with the possibility of its regulation. So, idling electric motor torque can be delivered with impulses and at high frequency continuously.

To save as much as battery power as possible, torque of an electric motor must be delivered with a decrease in the instantaneous torque value of an internal combustion engine below the average value on a cycle.

To save as much fuel as possible, torque of an electric motor must be delivered with a decrease in the instantaneous torque of internal combustion engine below a positive value of a cycle.

To make hybrid ICE-electric motor work more effective, torque of an electric motor should be delivered depending on the sign of the angular acceleration of the shaft in the ICE. With positive sign engine accelerates, with it is negative slows down.

To decide how much of a torque of an electric motor should be delivered, it should be contingent on to the value of the angular acceleration of the shaft in ICE.

Depending on the design and purpose of hybrid transmission, it is possible to deliver torque of an electric motor by any law, leading to reduce vibration in torque of a shaft in internal combustion engine.

As there is a lot of operating modes and designs, successful can be to use of combination of delivering momentum of an electric motor.

Hybrid systems have an internal combustion engine with disable cylinders to save fuel. However, existing systems achieve satisfactory result with the number of cylinders, multiples of 4, for example at GMC Yukon Denali hybrid 8-cylinder engine has 4 disconnected cylinders. The offered system will allow to align momentum at the moment of disabling any number of cylinders in any engine as the torque of electric motor is delivered instead of the momentum of disconnected, with the possibility of repetition or with the changed course on a shaft angle of rotation. It will allow to save fuel and improve comfort.

Each ICE has frequency of rotation, at which specific fuel consumption is minimum. This method allows more economical shift bearing point of an internal combustion engine, setting it in a zone of the minimum specific fuel consumption, or closer to it. The electric motor can be move to a brake mode (generator) to optimum frequency, and in a traction mode after optimum frequency, i.e. to establish internal combustion engine parameters on minimization of specific fuel consumption.

When operating a hybrid transmission on a sign and magnitude of a momentum of an electric motor can be control ICE parameters, such as the ignition or supply of a fuel. This will lead to improved environmental performance.

In brake a mode the breaking torque of a electric motor can be delivered with impulses on a shaft angle of rotation that will reduce unevenness.

Braking torque of an electric motor can be delivered continuously, but changing the angle of rotation of the shaft. It will allow to be braked more intensively.

Braking torque of the motor can be delivered with pulses to the angle of rotation of the shaft, and with the increase with increasing torque of internal combustion engine, and with the decrease with decreasing torque in the engine. This is the best mode braking with preservation of uniformity of a course.

If the braking torque of a electric motor delivered continuously, changing from the greatest negative value, and with reduction at decrease of a torque internal combustion engine, and with increase at increase in torque of internal combustion engine: we will receive a mode of intensive braking with fast achievement of the established value of delay.

If the braking torque of the electric motor delivers depending on degree of non-uniformity of rotation, with possibility of its regulation, then we will receive high uniformity on different modes.

If the braking torque of an electric motor deliver with increasing instantaneous torque of internal combustion engine above the average value over the cycle, then uniformity of rotation will be provide at the same time with a charging of batteries.

If the braking torque of an electric motor delivers with increasing instantaneous torque of internal combustion engine above positive value on a cycle, uniformity of rotation will raise.

Reaching effect when braking most accurately when controlling brake depending to the sign, as well as the value of angular acceleration of the shaft in the engine.

As there are a lot of conditions of use of hybrid transmission in a braking mode, the brake torque of the electric motor possible to deliver under any law leading to reduction of fluctuations of a torque on a shaft of an internal combustion engine and fuel economy.

Therefore possible to supply a braking torque of electric motor in combination of any of the described methods.

In the electric motor of hybrid transmission when using a proposed method torque or brake torque of the electric motor deliver frequency modulated or otherwise. It will allow to apply effective control systems of the electric motor.

1. Method of control of torque in a hybrid transmission includes: processing requests for a torque or braking, processing signals on the current status of engines, batteries and transmissions, giving commands to engines and transmissions, with additional processing the data about torque in combustion engine per revolution of the shaft in relation to the number of its cylinders, the technical condition, loaded, frequency of rotation and other parameters; in addition system is able to receive information from sensors, calculations or reference tables stored in their system, or a combination of these methods, and electric motor generates magnitude of the torque or braking torque at the time and angle of rotation of the shaft depending on the magnitude of the torque of combustion engine on the angle of rotation of the shaft and the uniformity of a given moment of the hybrid setup, including the possibility of regulation.

2. The method according to claim 1, whereby the torque in electric motor is pulsed by the angle of rotation of the shaft.

3. The method according to claim 1, according to which the electric motor's torque is applied continuously, but changing according to the angle of rotation of the shaft.

4. The methods in claim 2, according to which the torque of the electric motor is pulsed on the angle of rotation of the shaft, and decrease with the increase in torque of ICE, and a decrease with an increase in torque of internal combustion engine.

5. The method to claim 1, according to which torque of the electric motor is applied continuously, but varying from the smallest positive value, and decreases with the increase in torque of combustion engine, and decrease with an increase in torque of combustion engine.

6. The method according to claim 1, according to which the torque of an electric motor depends on the degree of irregularity in the rotation, with the possibility of its regulation.

7. The method according to claim 1, whereby the torque of an electric motor is supplied with a decrease in the instantaneous torque of combustion engine below the average of a cycle.

8. The method according to claim 1, whereby the torque of an electric motor is supplied with a decrease in the instantaneous torque of combustion engine below a positive value of a cycle.

9. The method according to claim 1, according to which torque of an electric motor is applied depending on the sign of the angular acceleration of the shaft of an internal combustion engine.

10. The method according to claim 1, according to which torque of an electric motor is applied depending on the value of the angular acceleration of the shaft of internal combustion engine.

11. The method according to claim 1, according to which the motor torque is applied by any law, leading to a decrease of oscillation of torque on the shaft of an internal combustion engine.

12. The method according to claim 1, according to which the electric motor torque is applied to the combination of any of the methods in claims 2-11.

13. The method according to claim 1, according to which one or more cylinders of a combustion engine switched off, and the electric motor torque is applied instead, with a possibility to repeat or change angle of rotation of the shaft.

14. The method according to claim 1, whereby the time the motor is fed in such a way as to set the parameters of the internal combustion engine to minimize the specific fuel consumption.

15. The method according to claim 1, according to which the moment of an electric motor sets parameters of the internal combustion engine to minimize fuel consumption.

16. The method according to claim 1, according to which braking torque of an electric motor is pulsed on the angle of rotation of the shaft.

17. The method according to claim 1, whereby the braking torque of the electric motor is fed continuously, but changing the angle of rotation of the shaft.

18. The method according to claims 1 and 16, according to which the braking momentum of the electric motor increases in case of increase of a torque of an internal combustion engine, and decreases in case of decrease of a torque of an internal combustion engine.

19. The method according to claim 1, according to which the braking torque of the electric motor is applied continuously, but varying from the largest negative value, and decreases with the decrease in torque combustion engine as well as with an increase in increasing torque of combustion engine.

20. The method according to claim 1, according to which the electric motor braking torque is applied according to the degree of irregularity of the rotation, with the possibility of its regulation.

21. The method according to claim 1, according to which the braking torque the electric motor is applied with an increase in the instantaneous torque of a combustion engine above the average of a cycle.

22. The method according to claim 1, according to which the braking torque the electric motor is applied with an increase in the instantaneous torque of a combustion engine above the positive value of a cycle.

23. The method according to claim 1, according to which the electric motor braking torque is applied according to the sign of the angular acceleration of the shaft of the combustion engine.

24. The method according to claim 1, according to which the electric motor braking torque is applied according to the value of the angular acceleration of the shaft of the combustion engine.

25. The method according to claim 1, according to which the braking torque an electric motor is applied through any law, leading to a decrease of oscillation of torque on the shaft of a combustion engine.

26. The method according to claim 1, according to which the electric motor's breaking torque is applied to the combination of any of the methods from claims 16-25.

27. The method according to claim 1, according to which torque or braking torque of an electric motor is applied frequency-modulated or otherwise.
